(19) United States
(12) Patent Application Publication
(10) Pub. No.: US 2026/0115946 A1
(43) Pub. Date: Apr. 30, 2026

(54) MAGNETIC SILENT ELECTRIC HAIR CLIPPER

(71) Applicant: DONGGUAN FENG MING TECHNOLOGY AND COMMUNICATIONS CO., LTD., Dongguan (CN)

(72) Inventors: Xuexuan WU, Dongguan (CN); Wei JIANG, Dongguan (CN)

(73) Assignee: DONGGUAN FENG MING TECHNOLOGY AND COMMUNICATIONS CO., LTD., Dongguan, GD (CN)

(21) Appl. No.: 18/926,346

(22) Filed: Oct. 25, 2024

(51) Int. Cl. B26B 19/28; B26B 19/06

(52) U.S. Cl. CPC B26B 19/28; B26B 19/06

(57) ABSTRACT

The present disclosure relates to a magnetic silent electric hair clipper, including a fixed blade and a moving blade, where a top of the moving blade is provided with a transmission portion, a first magnet is disposed in each of two opposite sidewalls of the transmission portion, an output shaft of a motor is provided with a second magnet, the second magnet is placed between the two sidewalls of the transmission portion and has the same magnetism as the first magnet, and the second magnet pushes the sidewalls on two sides in turn while making a circular motion about the output shaft, so that the moving blade swings left and right relative to the fixed blade. According to the present disclosure, the second magnet does not contact or collide with the transmission portion, so that noise generated when the motor drives the moving blade is greatly reduced.

### FIELD OF TECHNOLOGY

The present disclosure relates to the field of electric hair clippers, specifically to a magnetic silent electric hair clipper.

### BACKGROUND

The electric hair clipper is a common tool for haircutting and hairdressing, mainly used to trim human hair or animal hair, and usually has a reciprocating structure. A power source drives blades to reciprocate by a mechanical structure to cut the hair. To efficiently and quickly cut the hair, the motor is often used as a driving mechanism. Through high-speed rotation of the motor, a moving blade is driven by a transmission mechanism to move at a high speed on the surface of a fixed blade, thereby cutting the hair that passes through the fixed blade.

In the existing electric hair clipper, an output shaft of the motor is provided with an eccentric pin, the eccentric pin is inserted between a guide groove of a blade pad, and the fixed blade is driven to move left and right for cutting. However, in the existing structure, the contact between the eccentric pin and the guide groove of the blade pad inevitably leads to friction, so as to generate heat. The heat accelerates the wear of the plastic guide groove, which leads to an increase in a gap between the guide groove of the blade pad and the eccentric pin, and an increase in noise of the electric hair clipper during operation. The degree of wear of the left and right wear surfaces of the guide groove of the blade pad is uncontrollable, so the noise generated during motion is chaotic. As the wear increases, the blade also drops sharply in cutting effect until losing its cutting function.

The rotational speed of electric hair clippers on the market is basically below 8,000 rpm/min, and rarely reaches 10,000 rpm/min. This is closely related to the wear of the guide groove of the blade pad. If the rotational speed of the electric hair clipper is increased, the wear of the guide groove of the blade pad will increase geometrically, so that the service life of the electric hair clipper will be shortened, thereby seriously restricting the performance and iteration of the electric hair clipper product.

### SUMMARY

To solve the problems of wear between an eccentric pin on an output shaft of a motor and a guide groove in a moving blade, and high noise for an existing electric hair clipper during operation, the present disclosure provides a magnetic silent electric hair clipper.

A technical solution of the present disclosure is as follows:

A magnetic silent electric hair clipper, including a fixed blade and a moving blade driven by a motor to swing left and right relative to the fixed blade, where a top of the moving blade is provided with a blade pad, a first magnet is disposed in each of two opposite sidewalls of a guide groove of the blade pad, an output shaft of the motor is provided with a second magnet deviating from a shaft center of the output shaft, and the second magnet is placed between the two sidewalls of the guide groove and has the same magnetism as the first magnet, so that the second magnet pushes the sidewalls on two sides of the guide groove in turn while making a circular motion about the output shaft.

By use of the above technical solution, when the output shaft of the motor rotates, the second magnet moves back and forth between the two sidewalls. Due to the principle that like poles of the magnets repel each other, the second magnet pushes the adjacent sidewall with a repulsive force, so that the second magnet pushes the two opposite sidewalls of the guide groove in turn, thereby causing the moving blade to swing left and right on the fixed blade.

According to the present disclosure using the above solution, the moving blade assembly includes the moving blade, a guide block, and the blade pad, where the guide block is disposed at a bottom of the moving blade, and the fixed blade is provided with a sliding groove matched with the guide block; the guide block slides in the sliding groove; and the guide groove of the blade pad passes through a hollow opening of a fixed base. By use of the above technical solution, the guide block and the sliding groove cause the moving blade to move back and forth on the fixed blade based on a defined trajectory; and the moving blade is linked to the motor through the guide groove in the blade pad thereof to get power.

Further, two ends of the guide block are provided with nut grooves, nuts are mounted in the nut grooves, and first bolts penetrate through the blade pad and the moving blade in sequence from top to bottom and then is connected to the nuts. By use of the above technical solution, the blade pad, the moving blade, and the guide block are mounted together using the nuts and the first bolts to form a whole, thereby ensuring the structural stability of the moving blade; and detachable mounting of the bolts and the nuts facilitates disassembly and replacement of the moving blade.

Optionally, the moving blade is provided with a third magnet, and the third magnet attracts the fixed blade, so that the moving blade is attached to the fixed blade. By use of the above technical solution, there is a magnetic attractive force between the moving blade and the fixed blade, so that the moving blade is attached to the fixed blade, and blade teeth of the moving blade are attached to blade teeth of the fixed blade in an up-down manner, thereby improving the cutting effect of the electric hair clipper.

Further, the guide block is provided with a first accommodating groove, a groove bottom of the first accommodating groove is hollow, the third magnet is placed in the first accommodating groove, and a gap is reserved between the third magnet and the sliding groove. By use of the above technical solution, the first accommodating groove supports the third magnet above the fixed blade to reserve a gap from the fixed blade. The third magnet magnetically attracts but is not in contact with the fixed blade, so only a small area of the guide block is in contact with the sliding groove, which helps to reduce a frictional force when the moving blade slides on the fixed blade.

Optionally, the moving blade is provided with a fourth magnet, and the fourth magnet repels a fifth magnet on the fixed base, so that the moving blade is attached to the fixed blade. By use of the above technical solution, the fixed base pushes the moving blade in a direction of the fixed blade by a magnetic repulsive force, so that the moving blade is attached to the fixed blade, and blade teeth of the moving blade are attached to blade teeth of the fixed blade in an up-down manner, thereby improving the cutting effect of the electric hair clipper.

Further, the blade pad is provided with a second accommodating groove, and the fourth magnet is placed in the second accommodating groove; and the fixed base is provided with a third magnet groove, and the fifth magnet is placed in the third magnet groove. By use of the above technical solution, under a magnetic repulsive force between the fourth magnet and the fifth magnet, the fourth magnet is downwards and stably fixed in the second accommodating groove, the fifth magnet is upwards and stably fixed in the third magnet groove, and the fixed base pushes the moving blade down with the magnetic repulsive force.

Furthermore, the fifth magnet is in an inverted T shape, a section of the third magnet groove is in an inverted “U” shape, and the fifth magnet is placed in the third magnet groove from bottom to top.

According to the present disclosure using the above solution, an interior of the sidewall of the guide groove is hollow, a bottom of the guide groove is provided with an open hole communicating with the interior of the sidewall, and the first magnet is mounted in the sidewall through the open hole. By use of the above technical solution, the first magnet is mounted in the sidewall of the guide groove from inside of the open hole, so that the guide groove has a magnetic groove opening, where the groove opening is configured to place a ring magnet with the same magnetism.

Further, opposite surfaces of the sidewalls on the two sides of the guide groove are each provided with an opening to expose the first magnet. By use of the above technical solution, the design of the openings in the two sidewalls reduces the shielding effect on the first magnets in the sidewalls, and achieves a better magnetic repulsive effect between the second magnet in the guide groove and the first magnets in the sidewalls.

Further, a bottom of the blade pad is further provided with a support pad block, the support pad block is provided with a support portion corresponding to the open hole, and the support portion is inserted into the open hole and abuts against a bottom of the first magnet. By use of the above technical solution, the support pad block is detachably connected to the blade pad, the support portion of the support pad block is inserted into the open hole, and the support portion can abut against the first magnet in the sidewall and cause the first magnet to be located in an innermost part of the hollow sidewall, thereby ensuring that there is a sufficient magnetic force at a part of the sidewall near the ring magnet, and a larger magnetic repulsive force is generated between the first magnet and the ring magnet; and preventing the first magnet from shaking inside the sidewall.

Preferably, the first magnet is in a rectangular shape, and the support portion is provided with an inclined surface parallel to a side surface of the first magnet.

According to the present disclosure using the above solution, the second magnet is a ring magnet, the ring magnet is provided with an eccentric wheel, a center of one end surface of the eccentric wheel is provided with a connecting shaft, and the connecting shaft is connected to a center of the ring magnet; and the other end surface of the eccentric wheel is provided with an insertion hole deviating from a center, and the output shaft is inserted into the insertion hole. By use of the above technical solution, the output shaft of the motor is connected to a position deviating from a center of the eccentric wheel, and the ring magnet is connected to the center of the eccentric wheel, so that the ring magnet deviates from the shaft center of the output shaft of the motor, and thus the ring magnet makes a circular motion with the output shaft as a center when the motor rotates.

Further, the ring magnet includes a plurality of sector magnets and a fixing ring, where the plurality of sector magnets define the ring magnet and are fixed with the fixing ring.

According to the present disclosure using the above solution, a bottom of the fixed base and a bottom end of the fixed blade are provided with corresponding screw holes, and the fixed base and the fixed blade are mounted and connected by second bolts through the screw holes.

Optionally, the second bolts connect the fixed blade to the fixed base from bottom to top. By use of the technical solution, the second bolts penetrate into one side of the fixed base, then penetrate through the fixed blade, and are in threaded connection with the screw holes of the fixed blade.

Optionally, the second bolts connect the fixed base to the fixed blade from top to bottom. By use of the technical solution, the second bolts penetrate into one side of the fixed blade, then penetrate through the fixed base, and are in threaded connection with the screw holes of the fixed base.

According to the present disclosure using the above solution, the fixed base is provided with a circular support plate, the circular support plate is attached to an end surface of the motor, and the output shaft passes through a central hole of the circular support plate.

The present disclosure using the above solution has the following beneficial effects:

According to the present disclosure, the second magnet pushes the transmission portion (i.e., the guide groove) on the moving blade by a magnetic force based on the principle that like poles of the magnets repel each other, so that the second magnet does not contact or collide with the transmission portion, noise generated when the motor drives the moving blade is greatly reduced, and the electric hair clipper is silent during operation; moreover, due to the absence of contact friction, a friction loss during kinetic energy transfer can be reduced, and the efficiency can be improved;

Furthermore, the moving blade and the fixed blade are attached to each other by using a magnetic attractive force between the two or by using a magnetic repulsive force of the fixed base on the moving blade, so that stress is more uniform and stable, and a good attachment effect is still maintained after long-term use.

### BRIEF DESCRIPTION OF THE DRAWINGS

FIG. 1 is a schematic structural diagram of Embodiment 1 in the present disclosure;

FIG. 2 is a schematic diagram of a motor and a second magnet deviating from a shaft center of the motor;

FIG. 3 is an exploded structural view of Embodiment 1 in the present disclosure;

FIG. 4 is an enlarged view of a part A in FIG. 3;

FIG. 5 is an exploded structural view of a moving blade, a blade pad, and a guide block;

FIG. 6 is a schematic bottom view of a structure shown in FIG. 5;

FIG. 7 is a schematic structural diagram of a fixed base in Embodiment 1;

FIG. 8 is a schematic structural diagram of Embodiment 3 in the present disclosure;

FIG. 9 is an exploded structural view of Embodiment 3;

FIG. 10 is a schematic diagram of an eccentric wheel and a ring magnet in a preferred embodiment; and

FIG. 11 is an exploded structural view of an eccentric wheel and a ring magnet shown in FIG. 10.

In the drawings:
1. fixed blade;
11. sliding groove;
2. moving blade;
21. blade pad; 211, guide groove; 212. sidewall; 2121. opening; 213. second accommodating groove;
214. support pad block; 2141. support portion;
22. guide block; 221. nut groove; 222. nut; 223. first accommodating groove;
31. first bolt; 32. second bolt;
4. motor;
41. output shaft;
5. fixed base;
51. hollow opening; 52. circular support plate; 521. central hole; 53. fifth magnet; 54. third magnet groove;
6. first magnet;
7. second magnet;
71. eccentric wheel; 711. connecting shaft; 712. insertion hole; 713. magnet placement position;
72. ring magnet; 721. sector magnet; 722. fixing ring;
8. third magnet; and
9. fourth magnet.

### DETAILED DESCRIPTION OF THE EMBODIMENTS

To better understand the objectives, technical solutions, and technical effects of the present disclosure, the present disclosure is further described below with reference to the accompanying drawings and embodiments. It should be noted that similar reference signs and letters represent similar items in the following accompanying drawings. Therefore, once an item is defined in an accompanying drawing, it is not required to be further defined and explained in the subsequent accompanying drawings. It is hereby declared that the embodiments described below are only used to explain the present disclosure and are not intended to limit the present disclosure.

The terms “first”, “second”, “third”, “fourth”, and “fifth” are only for easy description, and cannot be construed as indicating or implying relative importance or implying the number of technical features.

### Embodiment 1

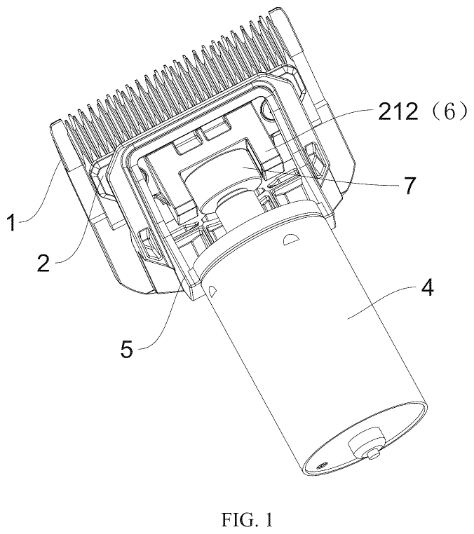

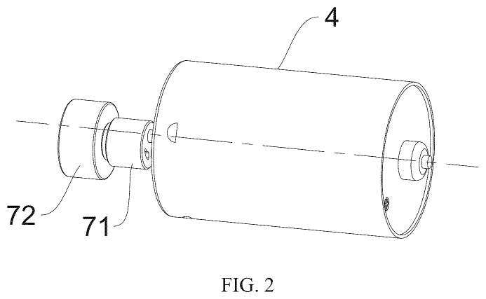

As shown in FIG. 1 to FIG. 3, a magnetic silent electric hair clipper includes a fixed blade 1 and a moving blade 2, where the moving blade 2 is driven by a motor 4 to swing left and right relative to the fixed blade 1, a top of the moving blade 2 is provided with a blade pad 21, a guide groove 211 in the blade pad 21 is formed with a transmission portion for transmitting power of the motor to the moving blade 2, a first magnet 6 is disposed in each of two opposite sidewalls 212 of the guide groove 211, an output shaft 41 of the motor 4 is provided with a second magnet 7 deviating from a shaft center of the output shaft 41, the second magnet 7 is placed between the two sidewalls 212 of the guide groove 211, and the second magnet 7 has the same magnetism as the first magnet 6, so that when the output shaft 41 of the motor 4 rotates, the second magnet 7 moves back and forth between the two sidewalls 212 while making a circular motion about the output shaft 41. Due to the principle that like poles of the magnets repel each other, the second magnet 7 pushes the adjacent sidewall 212 with a repulsive force, so that the second magnet 7 pushes the two opposite sidewalls 212 of the guide groove 211 in turn, thereby causing the moving blade 2 to swing left and right on the fixed blade 1.

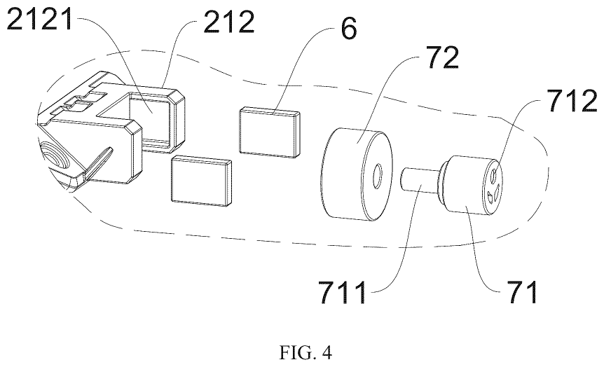

As shown in FIG. 4, in this embodiment, the second magnet 7 is a ring magnet 72, the ring magnet 72 is connected to an eccentric wheel 71, a center of one end surface of the eccentric wheel 71 is provided with a connecting shaft 711, and the connecting shaft 711 is connected to a center of the ring magnet 72; and the other end surface of the eccentric wheel 71 is provided with an insertion hole 712 deviating from a center, and the output shaft 41 is inserted into the insertion hole 712. The output shaft 41 of the motor 4 is connected to the insertion hole 712 deviating from a center of the eccentric wheel 71, and the ring magnet 72 is connected to the center of the eccentric wheel 71, so that the ring magnet 72 deviates from the shaft center of the output shaft 41 of the motor 4, and thus the ring magnet 72 makes a circular motion with the output shaft 41 as a center when the motor 4 rotates.

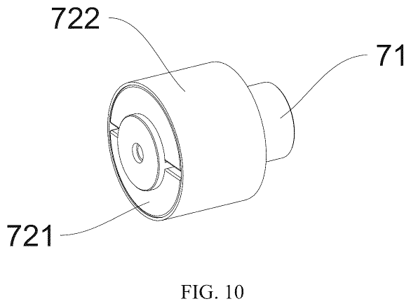

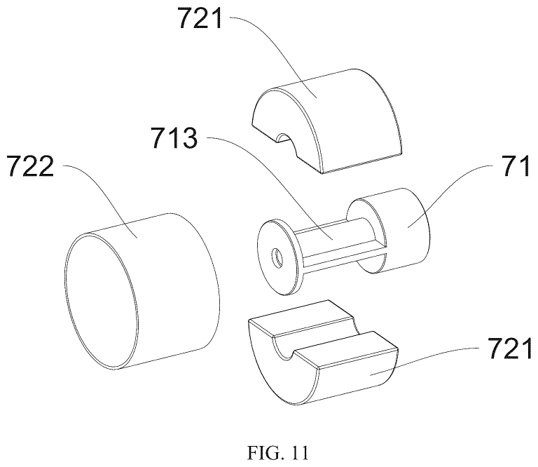

As shown in FIG. 10 and FIG. 11, in a preferred embodiment, the ring magnet 72 includes a plurality of sector magnets 721 and a fixing ring 722, where the plurality of sector magnets 721 are correspondingly placed on magnet placement positions 713 of the connecting shaft of the eccentric wheel 71 and are fixed with the fixing ring 722, and the plurality of sector magnets 721 define the ring magnet 72. For example, two sector magnets 721 are used, which are placed on two magnet placement positions 713 of the connecting shaft of the eccentric wheel 71 respectively and then are fixed with the plastic fixing ring 722. In other embodiments, four or other number of sector magnets may also be used.

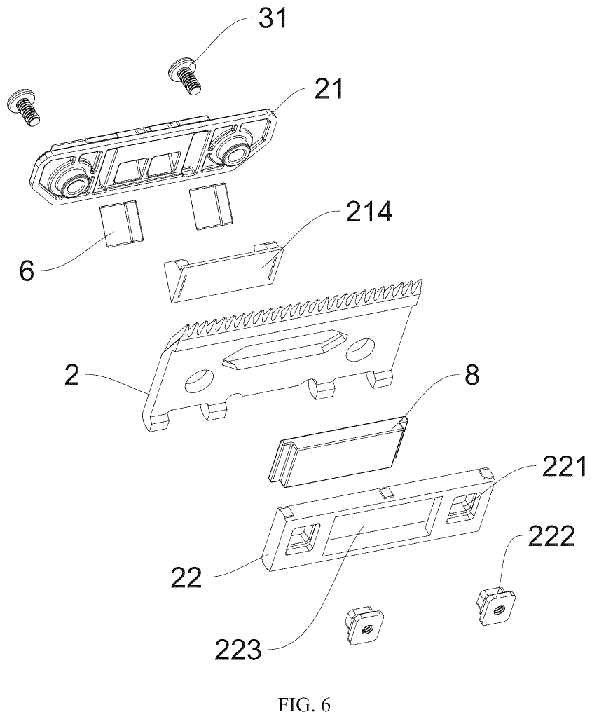

As shown in FIG. 6, in this embodiment, the top of the moving blade 2 is provided with the blade pad 21, a top of the blade pad 21 is provided with the guide groove 211, and the guide groove 211 is formed from the two opposite sidewalls 212 and has a groove opening capable of placing the first magnet 6. An interior of the sidewall 212 of the guide groove 211 is hollow and is formed with a cavity for placing the first magnet 6, and a bottom of the cavity is provided with an open hole communicating with the interior of the sidewall 212, so that the first magnet 6 can be conveniently mounted in the sidewall 212. Accordingly, the first magnet 6 is mounted in the sidewall 212 of the blade pad 21 from the open hole, so that the blade pad has a magnetic groove opening, where the groove opening is configured to place the second magnet 7 with the same magnetism.

It can be seen that in the present disclosure, the second magnet 7 pushes the guide groove on the moving blade 2 by a magnetic force based on the principle that like poles of the magnets repel each other, so that the second magnet 7 does not contact or collide with the blade pad, noise generated when the motor 4 drives the moving blade 2 is greatly reduced, and the electric hair clipper is silent during operation; moreover, due to the absence of contact friction, a friction loss during kinetic energy transfer can be reduced, and the efficiency can be improved.

To ensure the effect of a magnetic repulsive force between the first magnet 6 and the second magnet 7, referring to FIG. 4, opposite surfaces of the sidewalls 212 on two sides of the blade pad 21 are each provided with an opening 2121 to expose the first magnet 6, so that the shielding effect on the first magnet 6 in the sidewall 212 is reduced, and the second magnet 7 in the guide groove 211 has a larger mutual repulsive force (the magnetic repulsive force) with the adjacent first magnet 6.

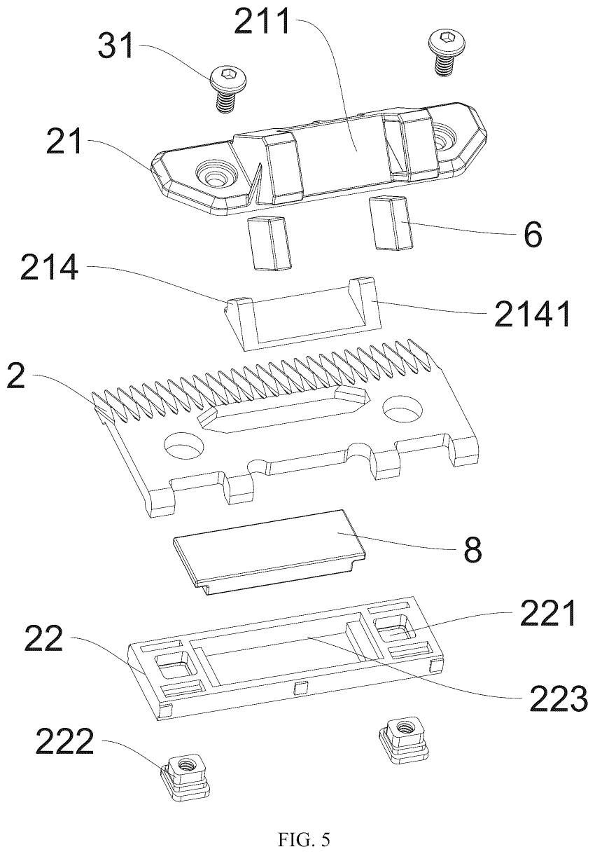

As shown in FIG. 5 and FIG. 6, a bottom of the blade pad 21 is further provided with a support pad block 214, the support pad block 214 is provided with a support portion 2141 corresponding to the open hole, and the support portion 2141 is inserted into the open hole and abuts against a bottom of the first magnet 6. Preferably, the first magnet 6 is in a rectangular shape, and the support portion 2141 is provided with an inclined surface parallel to a side surface of the first magnet 6. During assembly of the blade pad 21, first, the first magnet 6 is inserted into the sidewall 212 of the guide groove 211 along the open hole in the bottom, and then the support portion 2141 of the support pad block 214 is inserted into the open hole, so that the inclined surface of the support portion 2141 abuts against the first magnet 6, and the first magnet 6 is pushed into the sidewall 212 and firmly fixed, thereby effectively preventing the first magnet 6 from shaking inside the sidewall 212. Moreover, as the first magnet 6 is pushed into the sidewall 212, there is a sufficient magnetic force at a part of the sidewall 212 of the transmission portion near the second magnet 7, and a larger magnetic repulsive force is generated between the first magnet and the ring magnet 72.

It can be seen from the figures that the rectangular magnet (the first magnet 6) in the sidewall 212 is obliquely placed in the blade pad 21, so that the guide groove of the blade pad 21 has a deeper groove opening to better place the ring magnet 72, thereby achieving a larger action force between the first magnets 6 on two sides of the ring magnet 72 and the ring magnet, and higher stability of power transmission.

In other alternative embodiments, the first magnet and the blade pad are integrally formed by means of a plastic injection molding process. First, the first magnet is placed at a corresponding assembly position in a plastic mold for the blade pad, and then the plastic mold is injection-molded by an injection molding machine, so that the first magnet and the blade pad are formed into a whole. In this way, the production efficiency is improved, and an assembly structure of the first magnet and the blade pad is more stable.

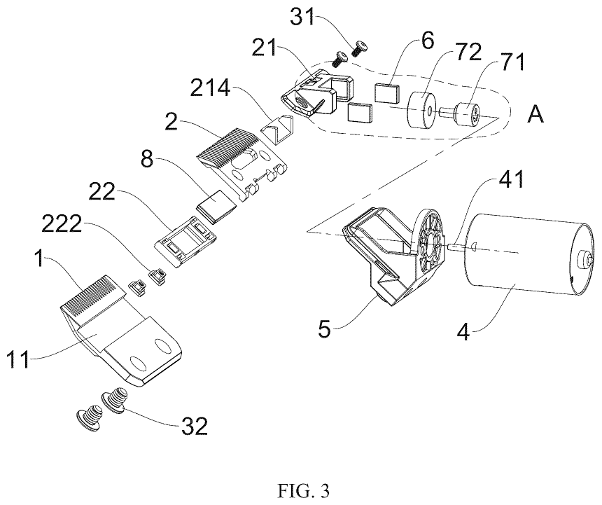

As shown in FIG. 3, in this embodiment, the magnetic silent electric hair clipper further includes a fixed base 5, where the fixed blade 1 is fixedly connected to the fixed base 5, and the moving blade 2 is located between the fixed blade 1 and the fixed base 5. Specifically, a bottom of the fixed base 5 and a bottom end of the fixed blade 1 are provided with corresponding screw holes, and the fixed base 5 and the fixed blade 1 are mounted and connected by second bolts 32 through the screw holes. During assembly, the second bolts 32 are connected to the fixed blade 1 and the fixed base 5 from bottom to top, and the second bolts 32 penetrate into one side of the fixed base 5, then penetrate through the fixed blade 1, and are in threaded connection with the screw holes of the fixed blade 1.

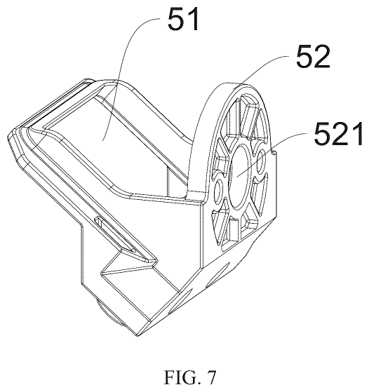

As shown in FIG. 7, the fixed base 5 is provided with a circular support plate 52, and the circular support plate 52 is attached to an end surface of the motor 4. The circular support plate 52 and the end surface of the motor 4 can be fixed by tightening the bolts to better provide stable support for the motor 4, and the output shaft 41 of the motor 4 passes through a central hole 521 of the circular support plate 52 and is in transmission connection with the transmission portion of the blade pad 21 by the second magnet 7. A plate surface of the circular support plate 52 is provided with radial structural ribs to enhance the structural strength of the circular support plate 52.

The fixed base 5 is further provided with a hollow opening 51, and the guide groove 211 is linked to the motor 4 through the hollow opening 51 of the fixed base 5 to get power. Therefore, the circular support plate 52 achieves stable power transmission between the motor 4 and a blade assembly (the moving blade 2 and the fixed blade 1).

As shown in FIG. 3, in this embodiment, a guide block 22 is disposed at a bottom of the moving blade 2, and the fixed blade 1 is provided with a sliding groove 11 matched with the guide block 22; the guide block 22 slides in the sliding groove 11; and the guide block 22 and the sliding groove 11 cause the moving blade 2 to move back and forth on the fixed blade 1 based on a defined trajectory.

As shown in FIG. 5, two ends of the guide block 22 are provided with nut grooves 221, nuts 222 are mounted in the nut grooves 221, and first bolts 31 penetrate through the blade pad 21 and the moving blade 2 in sequence from top to bottom and then is connected to the nuts 222. The nuts 222 are rectangular nuts, which are embedded into the nut grooves 221 of the guide block 22. The rectangular nuts are fixed in the nut grooves 221. The first bolts 31 are turned to be in fastening connection with the nuts 222. The blade pad 21, the moving blade 2, and the guide block 22 are mounted together using the nuts 222 and the first bolts 31 to form a whole, thereby ensuring the structural stability of the moving blade 2; and detachable mounting of the bolts and the nuts facilitates disassembly and replacement of the moving blade 2.

### Embodiment 2

In a blade head assembly of an existing electric hair clipper No. CN114633288A, for an attachment structure between a moving blade and a fixed blade, the moving blade presses against the fixed blade by an elastic force of a torsion spring to make them attached to each other. Contact parts between a blade pad on the moving blade and the torsion spring are two small contact surfaces, and a stress part is small. It is easy to cause inconsistence in pressures between two contact rods of the torsion spring and the blade pad due to a tolerance of left and right dimensions of the torsion spring and a tolerance of the contact surfaces of the blade pad. The blade is stressed unstably during cutting motion, which will also generate noise. Moreover, the contact parts between the torsion spring and the blade pad are prone to wear, thereby affecting the service life.

As shown in FIG. 5 and FIG. 6, in this embodiment, the rest of the structures of a magnetic silent electric hair clipper are the same as those in Embodiment 1, which can reduce noise generated when the motor 4 drives the moving blade 2. The difference is that the fixed blade 1 and the moving blade 2 are attached to each other based on the principle of magnetic attraction, instead of the torsion spring. A magnetic attractive force ensures stable and uniform stress when the fixed blade 1 and the moving blade 2 move relative to each other, and further reduces the noise. Specifically, a magnetic silent electric hair clipper includes a fixed blade 1 and a moving blade 2, where the moving blade 2 is provided with a third magnet 8, and the fixed blade 1 or a sliding groove 11 thereof is made of metal. The third magnet 8 can attract the fixed blade 1, so that the moving blade 2 is attached to the fixed blade 1, and blade teeth of the moving blade 2 are attached to blade teeth of the fixed blade 1 in an up-down manner, thereby achieving stable stress during cutting motion, and effectively reducing noise generated by the motion. Moreover, the fixed blade 1 and the moving blade 2 still maintain a good attachment effect after long-term use, thereby ensuring the cutting effect of the electric hair clipper.

In this embodiment, a guide block 22 is provided with a first accommodating groove 223, a groove bottom of the first accommodating groove 223 is hollow, and the third magnet 8 is placed in the first accommodating groove 223. When the first accommodating groove 223 supports the third magnet 8 above the sliding groove 11, the third magnet 8 is in a suspended state, and the third magnet 8 has a gap (the gap of about 0.2 mm) from the sliding groove 11 and is not in contact with the sliding groove, so that during sliding of the guide block 22 in the sliding groove 11, only a small area of the guide block 22 is in contact with the sliding groove 11, which helps to reduce a frictional force when the moving blade 2 slides on the fixed blade 1.

### Embodiment 3

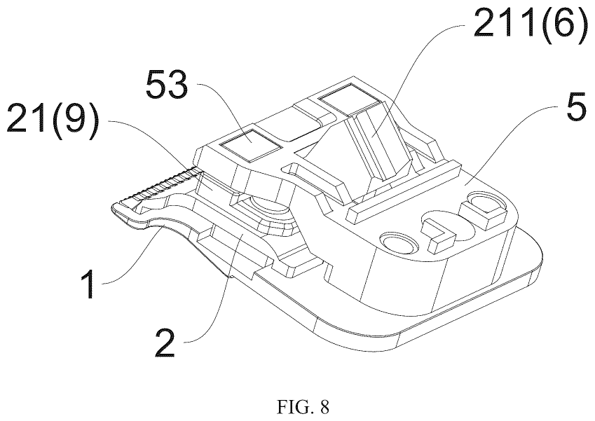

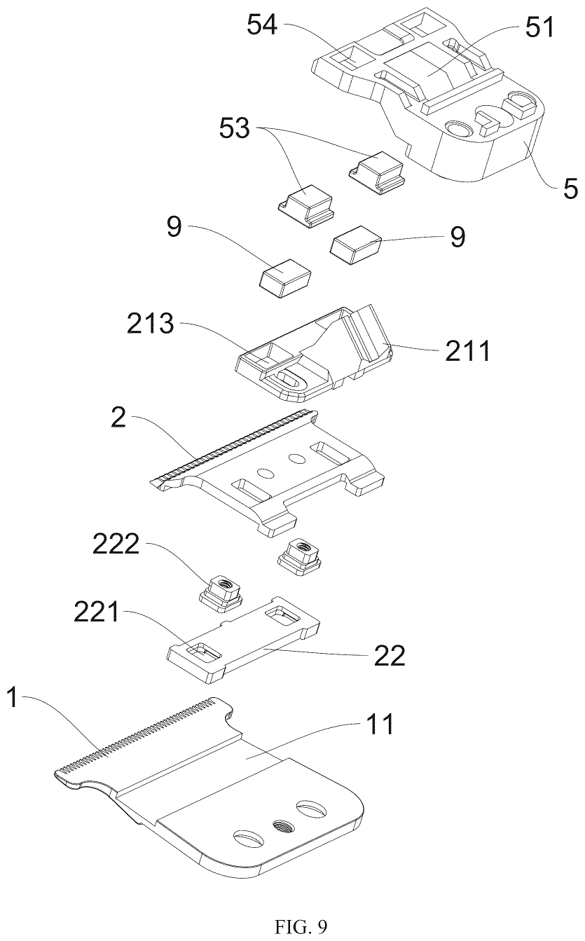

As shown in FIG. 8 and FIG. 9, a magnetic silent electric hair clipper includes a fixed blade 1, a moving blade 2, and a fixed base 5. The key design point is that the fixed base 5 is provided with a fifth magnet 53, and the moving blade 2 is provided with a fourth magnet 9. The fourth magnet 9 has opposite magnetism to the fifth magnet 53, so that the fixed base 5 has a downward pushing force on the moving blade 2, thereby causing the moving blade 2 to be attached to the fixed blade 1. This embodiment can also achieve the effects that blade teeth of the moving blade 2 are attached to blade teeth of the fixed blade 1 in an up-down manner, the moving blade 2 is stressed more stably in the process of getting kinetic energy of motion, noise generated by wear between contact surfaces of a torsion spring and a blade pad 21 is avoided, and the mute effect is further improved.

The blade pad 21 is provided with a second accommodating groove 213, and a fourth magnet 9 is placed in the second accommodating groove 213; and the fixed base 5 is provided with a third magnet groove 54, and the fifth magnet 53 is placed in the third magnet groove 54. Under a magnetic repulsive force between the fourth magnet 9 and the fifth magnet 53, the fourth magnet 9 is downwards and stably fixed in the second accommodating groove 213, the fifth magnet 53 is upwards and stably fixed in the third magnet groove 54, and the fixed base 5 pushes the moving blade 2 down with the magnetic repulsive force. The fifth magnet 53 is in an inverted T shape, a section of the third magnet groove 54 is in an inverted “U” shape, and the fifth magnet 53 is placed in the third magnet groove 54 from bottom to top.

In this embodiment, the fixed base 5 is fixedly connected to the fixed blade 1 by second bolts 32. Specifically, a bottom of the fixed base 5 and a bottom end of the fixed blade 1 are provided with corresponding screw holes, and the second bolts 32 connect the fixed base 5 to the fixed blade 1 from top to bottom. The second bolts 32 penetrate into one side of the fixed blade 1, then penetrate through the fixed base 5, and are in threaded connection with the screw holes of the fixed base 5.

### Embodiment 4

The rest of the structures of a magnetic silent electric hair clipper are the same as those in Embodiment 1. The difference is the structural part of a second magnet 7. Specifically, an output shaft 41 of a motor 4 is provided with an output wheel that rotates coaxially, and one side in the output wheel is provided with a magnet, so the magnet deviates from a wheel center of the output wheel. The output wheel moves coaxially with the output shaft 41 of the motor 4 during operation, and the magnet block inside the output wheel makes a circular motion with the output shaft 41 as a center, so as to move back and forth between left and right sidewalls 212 of a guide groove of a blade pad. Similarly, the magnet has the same magnetism as first magnets 6 in the two sidewalls 212, and has a magnetic repulsive force.

It is to be noted that when one element is referred to as being “fixed to” or “disposed on” another element, it may be directly located on another element or there may also be a centered element. When one element is regarded to be “connected to” another element, it may be directly connected to another element or there may also be a centered element.

The indicated orientations or positional relationships are based on orientations or positional relationships shown in the accompanying drawings, customary orientations or positional relationships when the product in this application is in use, or orientations or positional relationships customarily understood by those skilled in the art, only for the convenience of describing the present application and simplifying the description rather than indicating or implying that the apparatus or element referred to must have a particular orientation or be constructed and operated in a particular orientation, and therefore cannot be construed as limitations to the present application.

The technical features of the above embodiments may be combined arbitrarily. For the sake of brevity, all possible combinations of the technical features in the above embodiments are not described. However, the combinations of these technical features should be considered to be within the scope of this specification as long as there is no contradiction between them.

The above embodiments only express several implementations of the present disclosure and are described more specifically and detailedly, but cannot be construed as limitations to the scope of patent of the present disclosure. It should be pointed out that several modifications and improvements may also be made by those of ordinary skill in the art without departing from the conception of the present disclosure, and all fall within the scope of protection of the present disclosure. Therefore, the scope of patent protection of the present disclosure shall be subject to the appended claims.

What is claimed is:

1. A magnetic silent electric hair clipper, comprising a fixed blade and a moving blade driven by a motor to swing left and right relative to the fixed blade, wherein a top of the moving blade is provided with a blade pad, a first magnet is disposed in each of two opposite sidewalls of a guide groove of the blade pad, an output shaft of the motor is provided with a second magnet deviating from a shaft center of the output shaft, and the second magnet is placed between the two sidewalls of the guide groove and has the same magnetism as the first magnet, so that the second magnet pushes the sidewalls on two sides of the guide groove in turn while making a circular motion about the output shaft.

2. The magnetic silent electric hair clipper according to claim 1, wherein the moving blade is provided with a third magnet, and the third magnet attracts the fixed blade, so that the moving blade is attached to the fixed blade;
alternatively,
a moving blade assembly is provided with a fourth magnet, and the fourth magnet repels a fifth magnet on a fixed base, so that the moving blade is attached to the fixed blade.

3. The magnetic silent electric hair clipper according to claim 2, wherein the moving blade assembly comprises the moving blade, a guide block, and the blade pad, the guide block is disposed at a bottom of the moving blade, the fixed blade is provided with a sliding groove matched with the guide block, and the guide block slides in the sliding groove; and the guide groove of the blade pad passes through a hollow opening of the fixed base.

4. The magnetic silent electric hair clipper according to claim 3, wherein the guide block is provided with a first accommodating groove, a groove bottom of the first accommodating groove is hollow, the third magnet is placed in the first accommodating groove, and a gap is reserved between the third magnet and the sliding groove.

5. The magnetic silent electric hair clipper according to claim 3, wherein the blade pad is provided with a second accommodating groove, and the fourth magnet is placed in the second accommodating groove; and the fixed base is provided with a third magnet groove, and the fifth magnet is placed in the third magnet groove.

6. The magnetic silent electric hair clipper according to claim 1, wherein an interior of the sidewall of the guide groove is hollow, a bottom of the guide groove is provided with an open hole communicating with the interior of the sidewall, and the first magnet is mounted in the sidewall through the open hole.

7. The magnetic silent electric hair clipper according to claim 6, wherein opposite surfaces of the sidewalls on the two sides of the guide groove are each provided with an opening to expose the first magnet.

8. The magnetic silent electric hair clipper according to claim 6, wherein a bottom of the blade pad is further provided with a support pad block, the support pad block is provided with a support portion corresponding to the open hole, and the support portion is inserted into the open hole and abuts against a bottom of the first magnet.

9. The magnetic silent electric hair clipper according to claim 1, wherein the second magnet is a ring magnet, the ring magnet is connected to an eccentric wheel, a center of one end surface of the eccentric wheel is provided with a connecting shaft, and the connecting shaft is connected to a center of the ring magnet; and the other end surface of the eccentric wheel is provided with an insertion hole deviating from a center, and the output shaft is inserted into the insertion hole.

10. The magnetic silent electric hair clipper according to claim 9, wherein the ring magnet comprises a plurality of sector magnets and a fixing ring, and the plurality of sector magnets define the ring magnet and are fixed with the fixing ring.
